(19) United States
(12) Patent Application Publication
(10) Pub. No.: US 2005/0107160 A1
(43) Pub. Date: May 19, 2005

(54) [PHOTOGRAPHIC POINTER POSITIONING SYSTEM AND ITS OPERATION PROCESS]

(75) Inventors: Chiu-Hao Cheng, TAIPEI (TW); Ming-Kuo Cheng, TAIPEI (TW)

Correspondence Address: ZEROPLUS TECHNOLOGY CO., LTD., 2F-4, NO. 184, SEC. 4, CHUNG HSIAO EAST ROAD, TAIPEI, TW

(73) Assignee: ZEROPLUS TECHNOLOGY CO., LTD., CHUNGHO CITY, TAIPEI HSIEN. (TW)

(21) Appl. No.: 10/711,798

(22) Filed: Oct. 6, 2004

(30) Foreign Application Priority Data
Nov. 14, 2003 (TW) 092132069

(51) Int. Cl. A63F 13/00

(52) U.S. Cl. 463/37

(57) ABSTRACT

A photographic pointer positioning system includes a photographic pointing device connectable to a game machine main unit (system main unit) and a display screen through a communication interface thereof. The photographic pointing device uses a camera controlled by a control circuit to pick up the image of the display area of the display screen, an image processing circuit to process of the image signal, at least one reference sign to facilitate the processing of the image signal by the image processing circuit, a computing unit to calculate the coordinate value of the aiming point of the camera at the display screen subject to the data of the image signal obtained from the image processing circuit, and buttons for operation by user.

This application claims the priority benefit of Taiwan patent application number 092132069 filed on Nov. 14, 2003.

### BACKGROUND OF THE INVENTION

1. Field of the Invention

The present invention relates to pointer positioning system for use in a shooting game and more particularly, to a photographic pointer positioning system, which uses a camera to pick up the image signal of the whole display screen, an image processing circuit to process of the image signal, at least one reference sign to facilitate the processing of the image signal by the image processing circuit, a computing unit to calculate the coordinate value of the aiming point of the camera at the display screen subject to the data of the image signal obtained from the image processing circuit. A correction procedure is provided for correcting the aiming point of the photographic pointing device of the photographic pointer positioning system.

2. Description of the Related Art

Since the invention of CRT (cathode ray tube) in 1897, CRT display device has been intensively used in TV and computer for video output for the advantages of good picture quality of low manufacturing cost. When entered the era of 90's, TFT LCD, PDP (Plasma Display Panel) and FPD are developed and commercialized to challenge the leading position of CRT display device in market. TFT LCD is the most possible product to take the place of conventional CRT display device in market in the very near future. TFT LCD Nowadays, most personal computer systems are equipped with a TFT LCD instead of CDT (Color Display Tube) monitor.

Further, since the commercialization of PDP in 1985, many manufacturers were involved in developing big-size PDPs. During Nagano Winter Olympics in Japan, many big-size PDPs were announced and appeared on the market.

Following the development of PDP technology, “Reality 9200” using the LCD technology enables the Pixel Map Processor system to display all video signals in bright circumstance. Japan JVC create “Direct Drive Light Amplifier; D-DLA” for DHTV. Texas Instrument also disclosed so-called “DMD projecting technology. These products provide clear and bright picture quality. However, these products are still not satisfactory in function because of the drawbacks of short service life of projecting lamp bulbs (about 250˜500 hours) and high noise of cooling fan. Further, hologram 3D projection systems have also been developed.

As indicated above, display technology has been continuously developed at a fast speed. Same as the advanced TFT LCD and PDP, FED (Field Emission Display) follows CRT and CDT to enter the market.

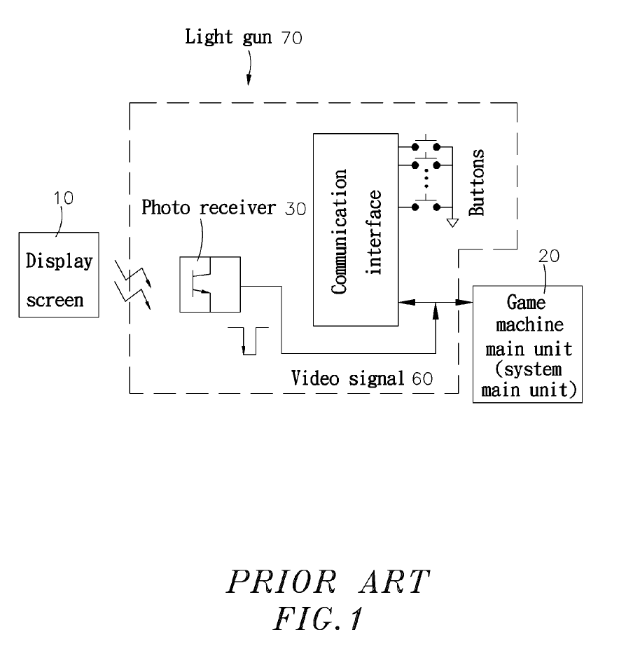

Further, light gun has been intensively used in shooting game machines to substitute for joystick to aim the object in the display screen, enhancing the reality of the game. Regular light guns for shooting game include first-generation light guns and second-generation light guns. When a first-generation light gun is used in a shooting game machine, the main unit of the game machine is controlled to calculate the coordinate value of the cursor. When a second-generation light gun is used in a shooting game machine, the light gun is controlled to calculate the coordinate value of the cursor and then to send the calculated result to the game machine main unit. FIG. 1 is a circuit block diagram showing a first-generation light gun used in a shooting game machine. The light gun 70 is connected to the game machine main unit 20 by a cable. When the user aimed the light gun 70 at the display screen 10 and fired a signal, the photo receiver 30 of the light gun 70 will receive the impact area signal from the display screen 10 and send the received impact area signal to the game machine main unit 20, so that the game program running by the game machine main unit 20 can calculate the coordinate value of the impact area at the display screen 10 subject to the data of the impact area signal and the video signal 60 from the game machine main unit 20 for further game program processing.

According to the conventional first-generation and second-generation light guns, the impact area signal or synchronous signal produced at the display screen is used for further signal processing or X,Y coordinate value calculation. Therefore, TFT LCD, PDP, projection system, or any of a variety of display means that cannot product such an impact area signal cannot be used with the aforesaid first-generation and second-generation light guns for playing a shooting game. Further, due to personal shooting habit or different location of aiming point, there may be an error between the aiming point and the impact area. In this case, a correction is necessary.

### SUMMARY OF THE INVENTION

The present invention has been accomplished under the circumstances in view. It is therefore the main object of the present invention to provide a photographic pointing device for photographic pointer positioning system, which fits any of a variety of display devices. It is another object of the present invention to provide a photographic pointer positioning system, which uses a correction procedure to correct any errors produced due to personal shooting habit or different location of sights at the light gun. To achieve these and other objects of the present invention, the photographic pointer positioning system comprises a photographic pointing device connectable to a game machine main unit (system main unit) and a display screen through a communication interface thereof. The photographic pointing device uses a camera controlled by a control circuit to pick up the image of the whole display area of the display screen, an image processing circuit to process of the image signal, at least one reference sign to facilitate the processing of the image signal by the image processing circuit, a computing unit to calculate the coordinate value of the aiming point of the camera at the display screen subject to the data of the image signal obtained from the image processing circuit, and buttons for operation by user.

### BRIEF DESCRIPTION OF THE DEAWINGS

FIG. 1 is a circuit block diagram showing a wired light gun used in a shooting game according to the prior art.

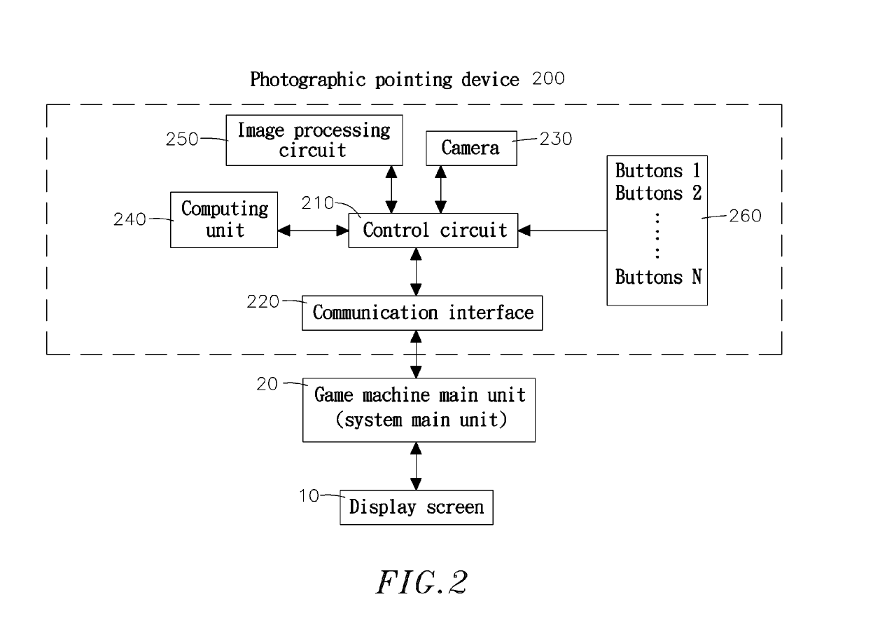

FIG. 2 is a circuit block diagram of a photographic pointer positioning system according to the first embodiment of the present invention.

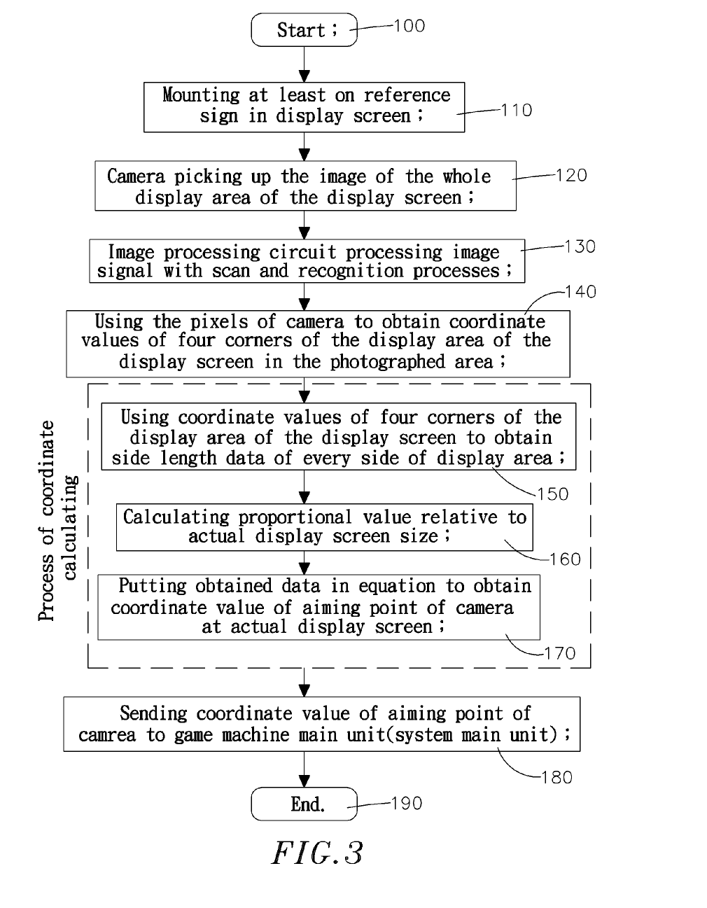

FIG. 3 is an operation flow chart of the photographic pointer positioning system according to the first embodiment of the present invention.

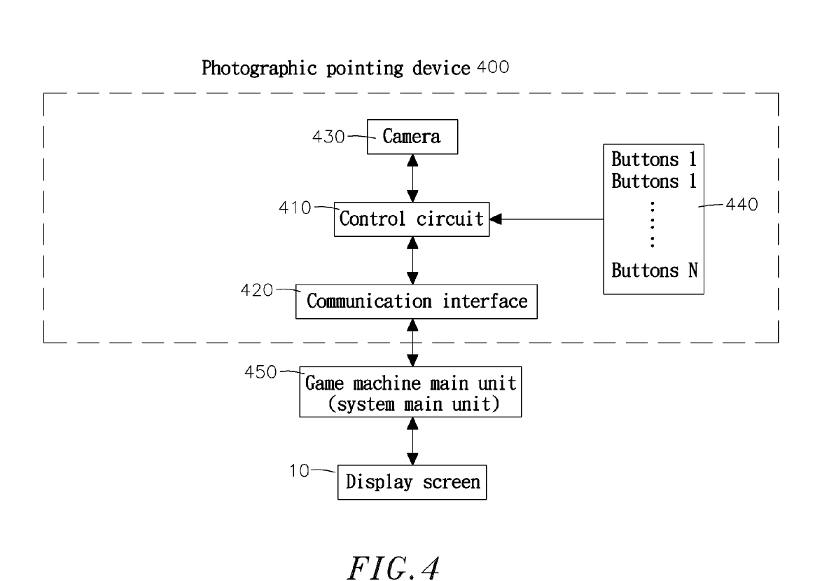

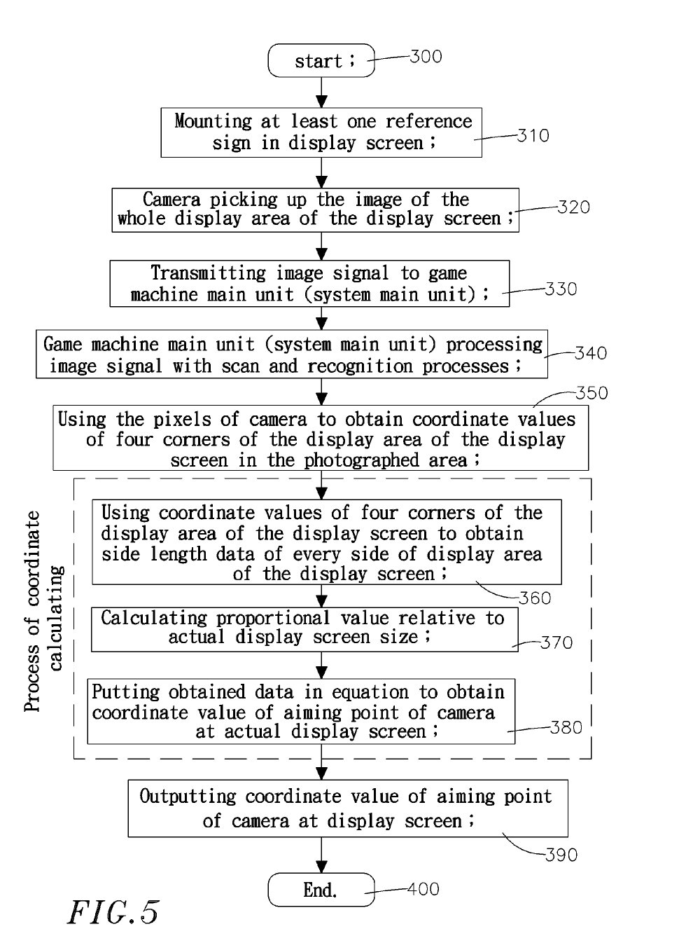

FIG. 4 is a circuit block diagram of a photographic pointer positioning system according to the second embodiment of the present invention.

FIG. 5 is an operation flow chart of the photographic pointer positioning system according to the second embodiment of the present invention.

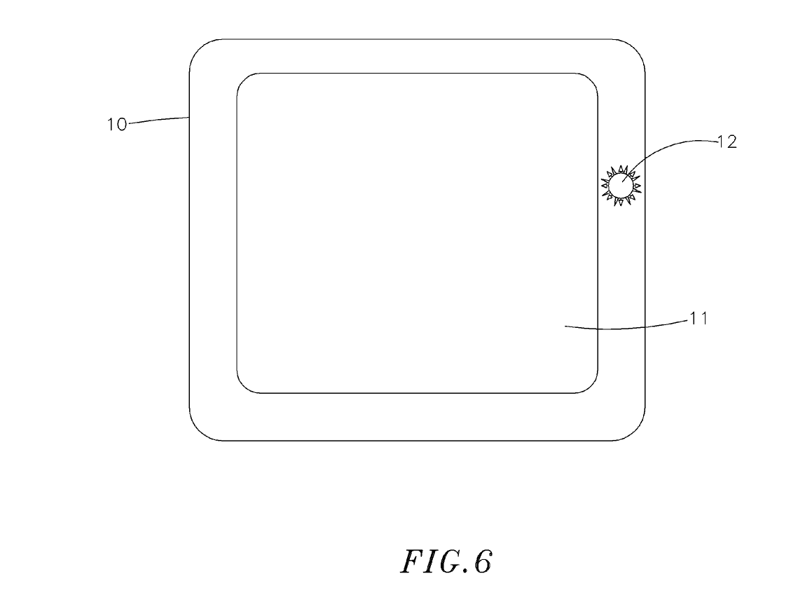

FIG. 6 is a schematic drawing showing one reference sign installed in the border area of the display screen around the display area according to the present invention.

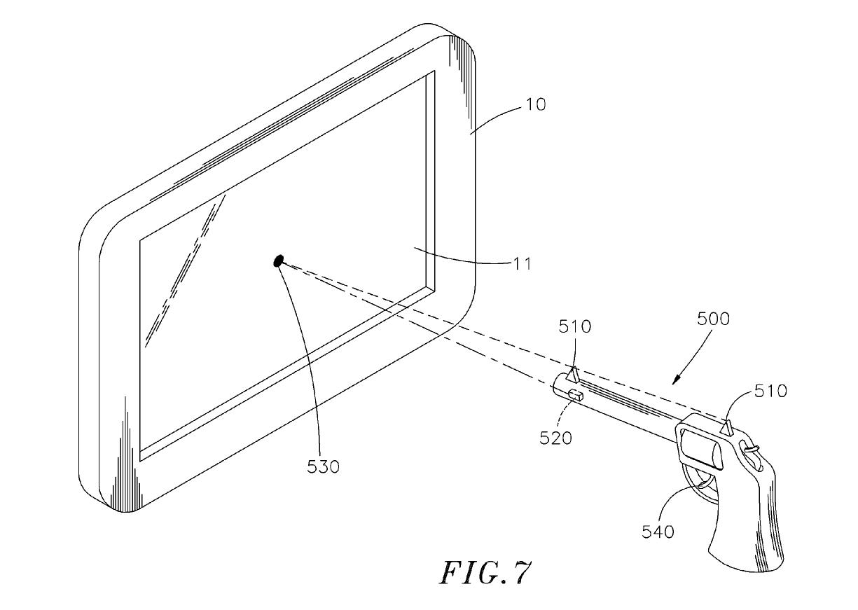

FIG. 7 is a schematic drawing showing a light gun-like photographic pointing device aimed at the center point of the display area of a display screen according to the present invention.

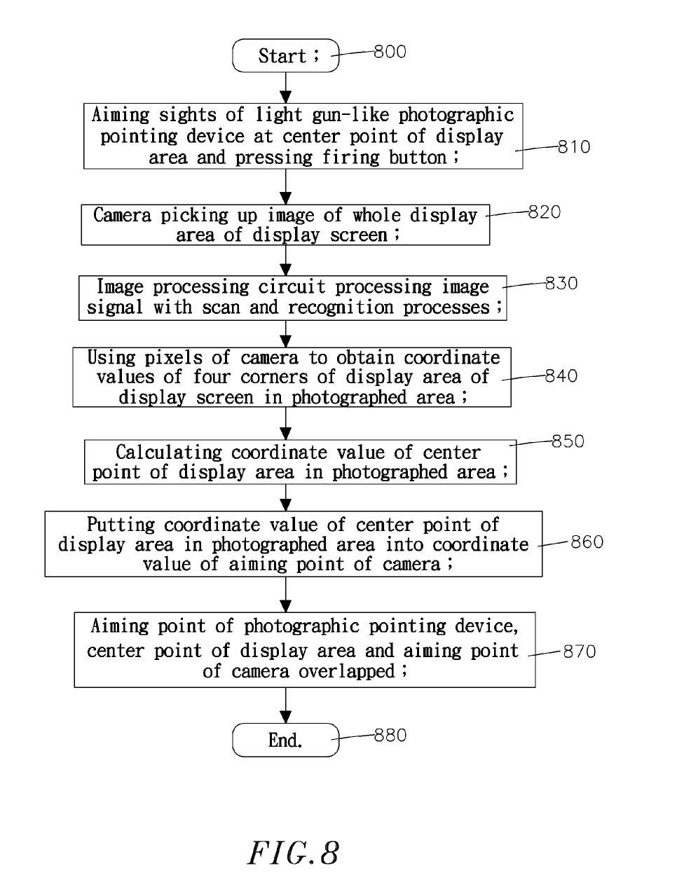

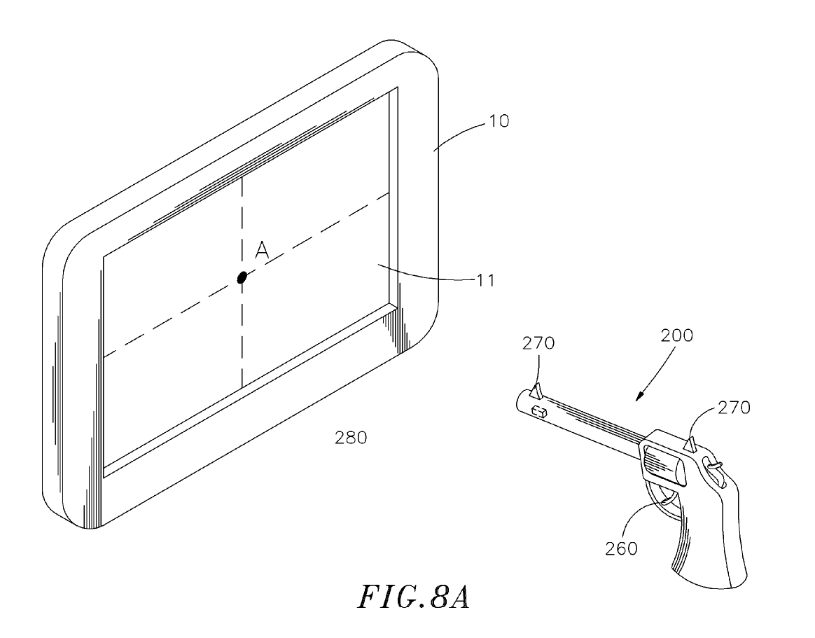

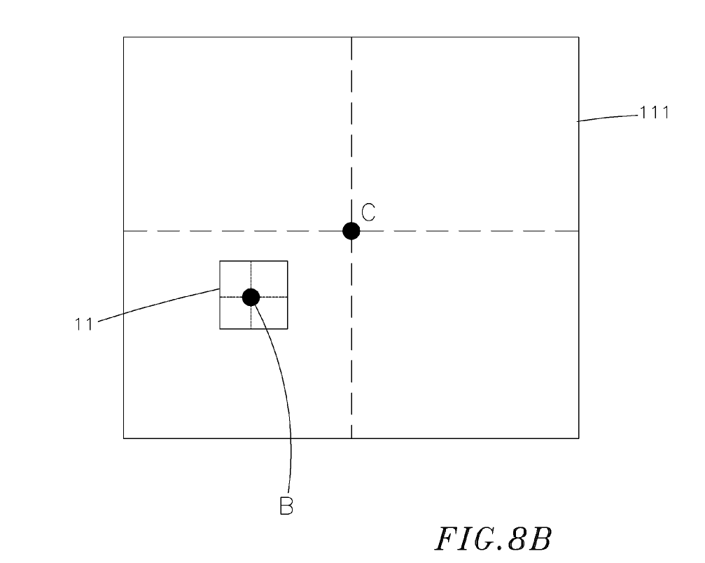

FIG. 8 is a correction flow chart of the photographic pointer positioning system according to the first embodiment of the present invention.

FIG. 8A is a schematic drawing showing the photographic pointing device of the photographic pointer positioning system of the first embodiment of the present invention aimed at the center point of the display area of the display screen according to the first embodiment of the present invention.

FIG. 8B is a schematic drawing explaining the relationship between the coordinate value B of the center point of the display area of the display screen in the photographed area and the coordinate value C of the aiming point of the camera at the display area of the display screen according to the first embodiment of the present invention.

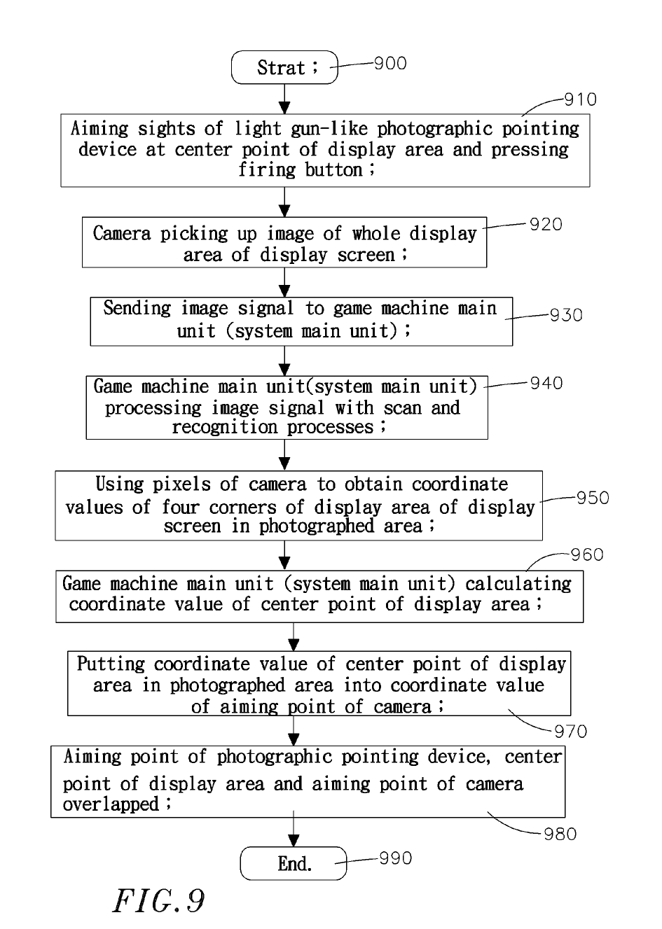

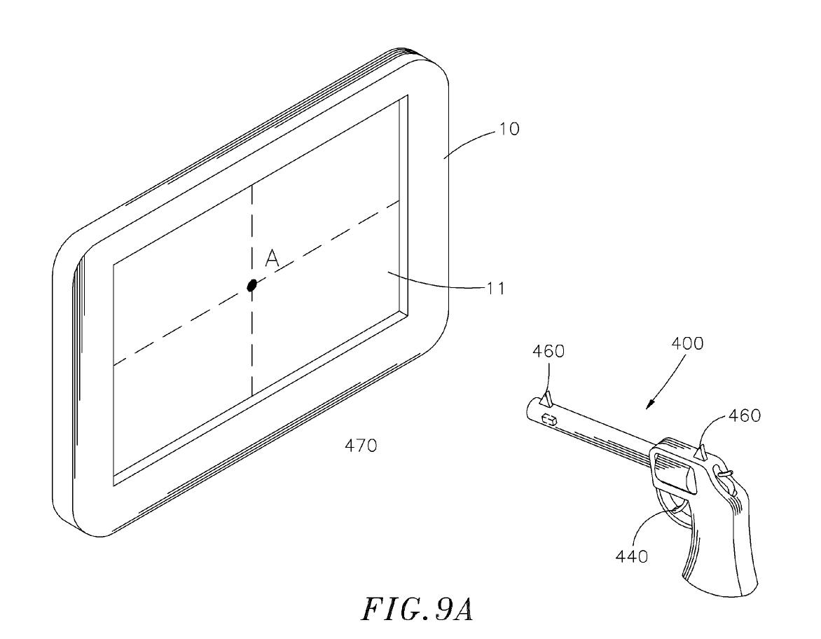

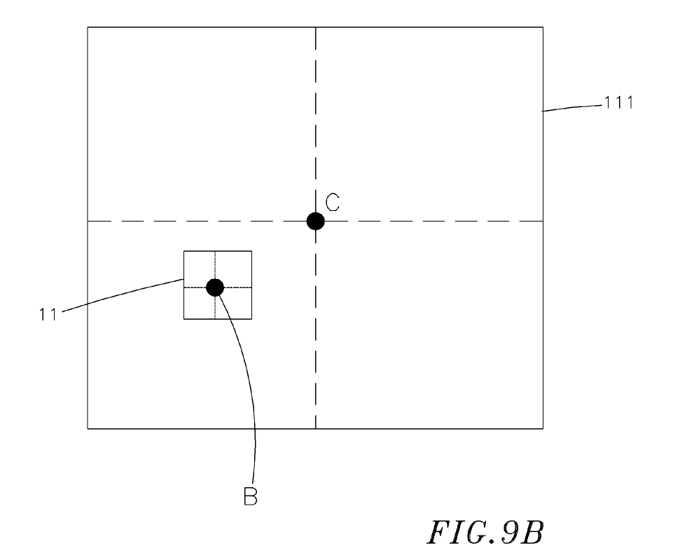

FIG. 9 is a correction flow chart of the photographic pointer positioning system according to the second embodiment of the present invention.

FIG. 9A is a schematic drawing showing the photographic pointing device of the photographic pointer positioning system of the first embodiment of the present invention aimed at the center point of the display area of the display screen according to the second embodiment of the present invention.

FIG. 9B is a schematic drawing explaining the relationship between the coordinate value B of the center point of the display area of the display screen in the photographed area and the coordinate value C of the aiming point of the camera at the display area of the display screen according to the second embodiment of the present invention.

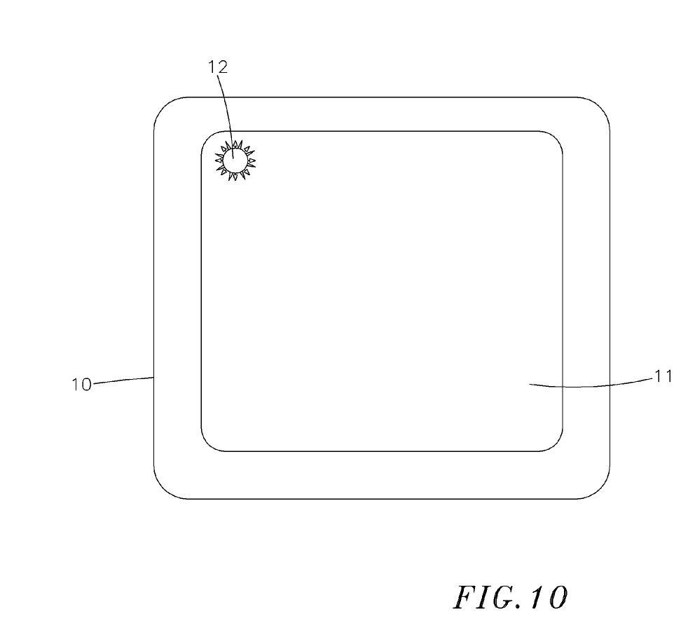

FIG. 10 is a schematic drawing showing another installation example of the reference sign within the display area according to the present invention.

### DETAILED DESCRIPTION OF EMBODIMENT

Referring to FIG. 2, a photographic pointer positioning system in accordance with the present invention comprises a photographic pointing device 200. According to the first embodiment of the present invention, the photographic pointing device 200 comprises a control circuit 210, a communication interface 220, a camera 230, a computing unit 240, an image processing circuit 250, and a set of buttons 260. By means of the communication interface 220, the photographic pointing device 200 is connectable to a game machine main unit (system main unit) 20, which has a display screen 10 connected thereto. The buttons 260 are electrically connected to the control circuit 210 for operation by the user to input commands to drive the game machine main unit (system main unit) 20 to run a predetermined game program. The control circuit 210 is electrically connected to the camera 230, the computing unit 240 and the image processing circuit 250 to control their operation. The camera 230 is controlled by the control circuit 210 to take the picture of a whole display area 11 of the display screen 10 and to transmit the obtained image signal to the control circuit 210, which in turn transmits the image signal to the image processing circuit 250 to receive scan and recognition processes. After scan and recognition processes, the image processing circuit 250 sends the processed image signal to the control circuit 210, enabling the control signal 210 to input the processed image signal into the computing unit 240, which computes the data of the processed image signal to find out the actual coordinate value of the aimed point of the camera 230 at the display screen 10 and then outputs the coordinate value to the control circuit 210 so that the control circuit 210 will transmit the coordinate value to the game machine main unit (system main unit) 20 for further game program processing.

Referring to FIGS. 2, 3 and 6, when the user uses the game machine main unit (system main unit) 20, the photographic pointing device 200 and the display screen 10 to play a shooting game, the photographic pointer positioning system is operated subject to the following procedure, which comprises the steps of:
(100) Start;
(110) Mounting at least one reference sign 12 in the border area of the display screen 10 around the display area 11;
(120) Controlling the camera 230 to pick up the image of the whole display area 11 of the display screen 10 and to send the image signal thus obtained back to the control circuit 210;
(130) Controlling the image processing circuit 250 to run scan and recognition processes by means of using the reference sign 12 for compare and to send the processed data back to the control circuit 210;
(140) Comparing the processed data obtained from the image processing circuit 250 to the pixels of the camera 230 to obtain the coordinate values of the four corners of the display area 11 of the display screen 10 in the photographed picture;
(150) Sending the coordinate values of the four corners of the display area 11 of the display screen 10 in the photographed picture and the coordinate value of the center point of the camera 230 to the computing unit 240, and driving the computing unit 240 to put these coordinate values into a distance formula so as to obtain every side length of the display area 11 of the display screen 10 in the photographed picture;
(160) Controlling the computing unit 240 to calculate the proportional value of every side length of the display area 11 of the display screen 10 in the photographed picture relative to the respective actual side length of display screen 10, and then to multiply the respective side length of the display area 11 of the display screen 10 in the photographed picture by the proportional value to obtain the respective actual side length data of the display area 11 of the display screen 10;
(170) Using the respective actual side length data of the display area 11 of the display screen 10 obtained from the computing unit 240 to write an affected quadratic simultaneous equation with two unknown, and then sending the related data to the computing unit 240 for enabling the computing unit 240 to find the answer of this affected quadratic simultaneous equation with two unknown and to send the X, Y values of the calculation result back to the control circuit 210;
(180) Using the X, Y values obtained from the computing unit 240 to determine the X, Y values to be the coordinate value of the aiming point of the camera 230, and then sending this coordinate value of the aiming point of the camera 230 to the game machine main unit (system main unit) 20 via the communication interface 220, for enabling the game machine main unit (system main unit) 20 to run further related program control based on the aiming point of the camera 230;
(190) End.

FIG. 4 shows an alternate form of the photographic pointer positioning system. According to this alternate form, the photographic pointer positioning system comprises a photographic pointing device 400, a game machine main unit (system main unit) 450, and a display screen 10. The photographic pointing device 400 comprises a control circuit 410, a communication interface 420, a camera 430, and a set of buttons 440. The display screen 10 is electrically connected to the game machine main unit (system main unit) 450. The communication interface 420 is connectable to the game machine main unit (system main unit) 450. The camera 430 is controlled by the control circuit 410 to take the picture of the whole display area 11 of the display screen 10 and to transmit the obtained image signal to the control circuit 410, which in turn transmit the obtained image signal to the game machine main unit (system main unit) 450 for enabling the game machine main unit (system main unit) 450 to find out the actual coordinates value of the aiming point of the camera 430 for further game program processing. The buttons 460 are signal emitting buttons of the camera 430 for operation by the user to input commands to play the game.

Referring to FIGS. 5 and 6 and FIG. 4 again, when the user uses the game machine main unit (system main unit) 450, the photographic pointing device 400 and the display screen 10 to play a shooting game, the photographic pointer positioning system is operated subject to the following procedure, which comprises the steps of:
(300) Start;
(310) Mounting at least one reference sign 12 in the border area of the display screen 10 around the display area 11;
(320) Controlling the camera 430 to pick up the image of the whole display area 11 of the display screen 10 and to send the image signal thus obtained back to the control circuit 410;
(330) Driving the control circuit 410 to send the image signal obtained from the camera 430 to the game machine main unit (system main unit) 450 via the communication interface 420;
(340) Controlling the game machine main unit (system main unit) 450 to run scan and recognition processes by means of using the reference sign 12 for compare;
(350) Driving the game machine main unit (system main unit) 450 to compare the processed data to the pixels of the camera 430 so as to obtain the coordinate values of the four corners of the display area 11 of the display screen 10 in the photographed picture;
(360) Driving the game machine main unit (system main unit) 450 to put the coordinate values of the four corners of the display area 11 of the display screen 10 in the photographed picture and the coordinate value of the center point of the camera 430 into a distance formula so as to obtain every side length of the display area 11 of the display screen 10 in the photographed picture;
(370) Controlling the game machine main unit (system main unit) 450 to calculate the proportional value of every side length of the area 11 of the display screen 10 in the photographed picture relative to the respective actual side length of display screen 10, and then to multiply every side length of the area 11 of the display screen 10 in the photographed picture by the respective proportional value so as to obtain the actual side length data of every side of the display screen 10;
(380) Driving the game machine main unit (system main unit) 450 to write an affected quadratic simultaneous equation with two unknown based on the actual side length data of every side of the display screen 10 and to find the answer of this affected quadratic simultaneous equation with two unknown so as to obtain the X, Y values of the aiming point of the camera 430;
(390) Driving the game machine main unit (system main unit) 450 to output the X, Y values of the aiming point of the camera 430 to the display screen 10 for further game program processing;
(400) End.

The photographic pointer positioning system of the present invention may be used in a computer system, big game machine, TV game machine, or computer terminal system. When used in a computer system, the photographic pointer positioning system will substitute for the functions of a mouse, a tablet, and a light gun.

FIG. 7 is a schematic drawing showing a light gun-like photographic pointing device 500 aimed at a center point 530 of the display area 11 of a display screen 10 according to the present invention. The light gun-like photographic pointing device 500 has a camera 520 provided at the periphery of the gun barrel thereof at one side below the elevation of the front and rear sights 510. A trigger 540 of the light gun-like photographic pointing device 500 serves as a firing button. Because the camera 520 and the sights 510 are arranged at different elevations, there may be an error between the aiming point and the actual coordinate value. Therefore, a correction procedure is necessary. The correction procedure of the photographic pointer positioning system according to the first embodiment of the present invention, as shown in FIGS. 2 and 8, includes the steps of:
(800) Start;
(810) Aiming the sights 270 of the light gun-like photographic pointing device 200 at the coordinate value A of the center point 280 of the display area 11 and then pressing the button 260 (see FIG. 8A);
(820) Driving the camera 230 to take the picture of the whole display area 11 of the display screen 10 so as to obtain a photographed area 111 (see FIG. 8B), and then driving the camera 230 to send the image signal of the photographed area 111 to the control circuit 210;
(830) Driving the control circuit 210 to send the image signal of the photographed area 111 to the image processing circuit 250 for running scan and recognition processes and then driving the image processing circuit 250 to send the processed data back to the control circuit 210;
(840) Comparing the processed data obtained from the image processing circuit 250 to the pixels of the camera 230 to obtain the coordinate values of the four corners of the display area 11 of the display screen 10 in the photographed area 111;
(850) Calculating the coordinate value B of the center point 280 of the display area 11 in the photographed area 111;
(860) Putting the coordinate value B of the center point 280 of the display area 11 in the photographed area 111 into the coordinate value C of the aiming point 290 of the camera 230 (see FIG. 8B);
(870) Therefore, the aiming point of the sights 270 of the light gun-like photographic pointing device 200, the center point 280 of the display area 11 and the aiming point 290 of the camera 230 are overlapped;
(880) End.

The correction procedure of the photographic pointer positioning system according to the second embodiment of the present invention, as shown in FIGS. 4 and 9, includes the steps of:
(900) Start;
(910) Aiming sights 460 of the light gun-like photographic pointing device 400 at a coordinate value A of a center point 470 of the display area 11 and then pressing the button 440 (see FIG. 9A);
(920) Driving the camera 430 to take the picture of the whole display area 11 of the display screen 10 so as to obtain a photographed area 111 (see FIG. 9B), and then driving the camera 430 to send the image signal of the photographed area 111 to the control circuit 410;
(930) Driving the control circuit 410 to send the image signal of the photographed area 111 to the game machine main unit (system main unit) 450 through the communication interface 420;
(940) Driving the game machine main unit (system main unit) 450 to run scan and recognition processes subject to the image signal of the photographed area 111 received from the control circuit 210;
(950) Driving the game machine main unit (system main unit) 450 to compare the processed image signal data to the pixels of the camera 430 so as obtain the coordinate values of the four corners of the display area 11 of the display screen 10 in the photographed area 111;
(960) Driving the game machine main unit (system main unit) 450 to calculate the coordinate value B of the center point 470 of the display area 11 in the photographed area 111;
(970) Putting the coordinate value B of the center point 470 of the display area 11 in the photographed area 111 into the coordinate value C of the aiming point 480 of the camera 430 (see FIG. 9B);
(980) Therefore, the aiming point of the sights 460 of the light gun-like photographic pointing device 400, the center point 470 of the display area 11 and the aiming point 480 of the camera 430 are overlapped;
(990) End.

In the aforesaid embodiments, the communication interface 220 or 420 of the photographic pointing device 200 or 400 can be a USB interface, 1394 interface, PS2 interface, or any suitable interface connectable to the game machine main unit (system main unit) 20 or 450 through a signal line for signal transmission between the control circuit 210 or 410 and the game machine main unit (system main unit) 20 or 450.

According to the present invention, the communication interface 220 or 420 is a wireless transmitting receiving interface having installed therein a wireless transmitter and a wireless receiver. The game machine main unit (system main unit) 20 or 450 has a corresponding wireless transmitter receiver module for wireless communication with the communication interface 220 or 420.

Further, the aforesaid reference sign 12 can be an illuminator formed of a light emitting diode, bulb, or any suitable light emitting materials. In the aforesaid first and second embodiments of the present invention, the reference sign 12 is installed in the border area of the display screen 10 around the display area 11. Alternatively, the reference sign 12 can be installed within the display area 11 of the display screen 10 (see FIG. 10).

Although a particular embodiment of the invention has been described in detail for purposes of illustration, various modifications and enhancements may be made without departing from the spirit and scope of the invention. Accordingly, the invention is not to be limited except as by the appended claims.

1. A photographic pointer positioning system comprising a game machine main unit (system main unit), a display screen connected to said game machine main unit (system main unit) for video output, and a photographic pointing device connectable to said game machine main unit (system main unit), said photographic pointing device comprising a control circuit, a communication interface, a camera, at least one reference sign, a computing unit, an image processing circuit, and a set of buttons, wherein:
said control circuit controls the operation of said camera and receives image signal from said camera;
said camera is controlled by said control circuit to take the picture of a whole display area of said display screen and to transmit the obtained image signal to said control circuit;
said at least one reference sign is respectively mounted in said display screen for reference in scan and recognition processing to be done by said image processing circuit to accelerate the processing speed;
said image processing circuit is controlled by said control circuit to process the image signal received from said camera through scan and recognition processes and to send the processed data back to said control circuit;
said computing unit is controlled by said control circuit to calculate the coordinate value of the aiming point of said camera at said display screen subject to the data of the image signal obtained from said image processing circuit and to output the calculated coordinate value to said control circuit;
said communication interface is controlled by said control circuit to transmit the calculated coordinate value of the aiming point of said camera at said display screen to said game machine main unit (system main unit) for further processing;
said buttons are respectively electrically connected to said control circuit for operation by user.

2. The photographic pointer positioning system as claimed in claim 1, wherein said at least one reference sign is respectively formed of an illuminator.

3. The photographic pointer positioning system as claimed in claim 2, wherein said illuminator is a light emitting diode, bulb or any suitable light emitting materials.

4. The photographic pointer positioning system as claimed in claim 1, wherein said at least one reference sign is respectively installed in the border area of said display screen around said display area.

5. The photographic pointer positioning system as claimed in claim 1, wherein said at least one reference sign is respectively installed within said display area of said display screen.

6. The photographic pointer positioning system as claimed in claim 1, wherein said game machine main unit (system main unit) is a computer system, big game machine, TV game machine or computer terminal system.

7. The photographic pointer positioning system as claimed in claim 1, wherein said communication interface is connected to said game machine main unit (system main unit) by a signal line for wire communication with said game machine main unit (system main unit).

8. The photographic pointer positioning system as claimed in claim 1, wherein said communication interface is a wireless communication interface for wireless communication with said game machine main unit (system main unit).

9. The photographic pointer positioning system as claimed in claim 1, wherein said photographic pointing device provides the functions of an optical mouse, a tablet and a light gun.

10. A photographic pointer positioning system comprising a game machine main unit (system main unit), a display screen connected to said game machine main unit (system main unit) for video output, and a photographic pointing device connectable to said game machine main unit (system main unit), said photographic pointing device comprising a control circuit, a communication interface, a camera, at least one reference sign, and a set of buttons, wherein:
said control circuit controls the operation of said camera and receives image signal from said camera;
said camera is controlled by said control circuit to take the picture of a whole display area of said display screen and to transmit the obtained image signal to said control circuit,
said at least one reference sign is respectively mounted in said display screen for reference in scan and recognition processing to be done by said game machine main unit (system main unit) to accelerate the processing speed;
said communication interface is controlled by said control circuit to transmit the image signal from said camera to said game machine main unit (system main unit) for further scan and recognition processing;
said buttons are respectively electrically connected to said control circuit for operation by user;
said game machine main unit (system main unit) calculates the coordinate value of the aiming point of said camera at said display screen subject to the image signal received from said camera and outputs the calculated data to said display screen for output.

11. The photographic pointer positioning system as claimed in claim 10, wherein said at least one reference sign is respectively formed of an illuminator.

12. The photographic pointer positioning system as claimed in claim 11, wherein said illuminator is a light emitting diode, bulb or any suitable light emitting materials.

13. The photographic pointer positioning system as claimed in claim 10, wherein said at least one reference sign is respectively installed in the border area of said display screen outside the display area of said display screen.

14. The photographic pointer positioning system as claimed in claim 10, wherein said at least one reference sign is respectively mounted within the display area of said display screen.

15. The photographic pointer positioning system as claimed in claim 10, wherein said game machine main unit (system main unit) is a computer system, big game machine, TV game machine or computer terminal system.

16. The photographic pointer positioning system as claimed in claim 10, wherein said communication interface is connected to said game machine main unit (system main unit) by a signal line for wire communication with said game machine main unit (system main unit).

17. The photographic pointer positioning system as claimed in claim 10, wherein said communication interface is a wireless communication interface for wireless communication with said game machine main unit (system main unit).

18. The photographic pointer positioning system as claimed in claim 10, wherein said photographic pointing device provides the functions of an optical mouse, a tablet and a light gun.

19. A photographic pointer positioning processing process used in the photographic pointer positioning system comprising a game machine main unit (system main unit), a display screen connected to said game machine main unit (system main unit) for video output, and a light gun-like photographic pointing device connectable to said game machine main unit (system main unit), said photographic pointing device comprising sights, a control circuit, a communication interface, a camera, at least one reference sign, a computing unit, an image processing circuit, and a set of buttons including a firing button, said photographic pointer positioning processing process comprising the steps of:
(A) Start;
(B) Aiming the sights of said light gun-like photographic pointing device at a center point of the display area of said display screen and then pressing said firing button;
(C) Driving said camera to take the picture of the whole display area of said display screen and to send the image signal thus obtained back to said control circuit;
(D) Driving said control circuit to send the image signal to said image processing circuit for running scan and recognition processes and then driving said image processing circuit to send the processed data back to said control circuit;
(E) Comparing the processed data obtained from said image processing circuit to the pixels of said camera to obtain the coordinate values of the four corners of the display area of the display screen in the photographed area;
(F) Calculating the coordinate value of the center point of the display area of said display screen in the photographed area;
(G) Putting the coordinate value of the center point of the display area of said display screen in the photographed area into the coordinate value of the aiming point of said camera;
(H) The aiming point of the sight of said light gun-like photographic pointing device, the center point of the display area and the aiming point of said camera are overlapped;
(I) End.

20. A photographic pointer positioning processing process used in the photographic pointer positioning system comprising a game machine main unit (system main unit), a display screen connected to said game machine main unit (system main unit) for video output, and a light gun-like photographic pointing device connectable to said game machine main unit (system main unit), said photographic pointing device comprising sights, a control circuit, a communication interface, a camera, at least one reference sign, and a set of buttons including a firing button, said photographic pointer positioning processing process comprising the steps of:
(A) Start;
(B) Aiming the sight of said light gun-like photographic pointing device at a center point of the display area of said display screen and then pressing said firing button;
(C) Driving said camera to take the picture of the whole display area of said display screen and to send the image signal thus obtained back to said control circuit;
(D) Driving said control circuit to send the image signal to said game machine main unit (system main unit) through said communication interface;
(E) Driving said game machine main unit (system main unit) to run scan and recognition processes subject to the image signal of received from said control circuit;
(F) Driving said game machine main unit (system main unit) to compare the processed image signal data to the pixels of said camera so as obtain the coordinate values of the four corners of the display area of said display screen in the photographed area;
(G) Driving said game machine main unit (system main unit) to calculate the coordinate value of the center point of the display area of said display screen in the photographed area;
(H) Putting the coordinate value of the center point of the display area of said display screen in the photographed area into the coordinate value of the aiming point of said camera;
(I) The aiming point of the sight of said light gun-like photographic pointing device, the center point of the display area and the aiming point of said camera are overlapped;
(J) End.
